(19) United States
(12) Patent Application Publication
(10) Pub. No.: US 2012/0274688 A1
(43) Pub. Date: Nov. 1, 2012

(54) LIQUID EJECTING HEAD AND LIQUID EJECTING APPARATUS

(75) Inventors: Toshiya OKADA, Chino (JP); Yoichi YAMADA, Shiojiri (JP); Masaru KOBASHI, Matsumoto (JP); Toshikazu ONO, Kamina (JP)

(73) Assignee: SEIKO EPSON CORPORATION, Tokyo (JP)

(21) Appl. No.: 13/453,559

(22) Filed: Apr. 23, 2012

(30) Foreign Application Priority Data
Apr. 26, 2011 (JP) 2011-097814

(51) Int. Cl. B41J 29/38

(52) U.S. Cl. 347/10

(57) ABSTRACT

A liquid ejecting head is provided in which a conductive plate is provided between a piezoelectric vibrator and a pressure chamber, and the conductive plate and the piezoelectric vibrator are electrically insulated from each other. By applying a voltage to the conductive plate, the ink ejected from the nozzles is positively charged, and mist generated by dividing the ink during flight is collected by a mist absorbing member of a mist collecting unit.

The entire disclosure of Japanese Patent Application No. 2011-097814, filed Apr. 26, 2011 is expressly incorporated by reference herein.

### BACKGROUND

1. Technical Field

The present invention relates to a liquid ejecting head used in a liquid ejecting apparatus such as an ink jet printing apparatus, and a liquid ejecting apparatus having the same, and particularly, to a liquid ejecting head and a liquid ejecting apparatus which eject a liquid in a pressure chamber from nozzles by driving of a pressure generating unit.

2. Related Art

A liquid ejecting apparatus is provided with a liquid ejecting head, and is an apparatus that ejects various liquids from the ejecting head. As the liquid ejecting apparatus, for example, there is an image printing apparatus such as an ink jet printer and an ink jet plotter, but recently, the liquid ejecting apparatus has been applied to various production devices, taking advantage of the feature that it is possible to accurately land a very small amount of liquid at a predetermined position. For example, the liquid ejecting apparatus is applied to a display producing apparatus that produces a color filter of a liquid crystal display or the like, an electrode forming apparatus that forms electrodes of an organic EL (Electro Luminescence) display, an FED (Field Emission Display), and the like, and a chip producing apparatus that produces a bio-chip (biochemical element). In a printing head for an image printing apparatus, a liquid ink is ejected. In a color material ejecting head for a display producing apparatus, liquids of color materials of R (Red), G (Green), and B (Blue) are ejected. In an electrode material ejecting head for an electrode forming apparatus, a liquid electrode material is ejected. In a bio-organic matter ejecting head for the chip producing apparatus, a solution of a bio-organic matter is ejected.

In the printing head used in the printer or the like, recently, there is a tendency towards reducing the liquid amount of ink ejected from nozzles according to a demand for improvement of an image. To reliably land such a liquid droplets of such a small amount on a printing medium, the initial velocity of the liquid droplets is set relatively high. Accordingly, the liquid droplets ejected from the nozzles are stretched during flying, and are divided into the leading main liquid droplets (main liquid droplets) and the subsequent satellite liquid droplets (sub-liquid droplets). A part or all of the satellite liquid droplets, the velocity of which is rapidly decreased by viscosity resistance of the air, do not reach the printing medium and may become mist. From this, the satellite liquid droplets (hereinafter, referred to as mist) which become the mist contaminate the inside of the apparatus, and cause an operation defect by attachment to an easily charged member such as the printing head and an electric circuit.

To prevent such inconvenience, the liquid droplets ejected from the nozzles are charged, an electric field is formed between a nozzle formation face of the printing head and a support member (a platen or a base material) supporting the printing medium at the time of printing, and the liquid droplets are apt to be positively attracted to the support member and to land on the printing medium (for example, see JP-A-10-278252 and JP-A-2004-202867).

However, as shown in a schematic diagram of FIG. 7A, in a course in which the ink ejected from the nozzles 64 of the printing head grows toward the printing medium P and the support member 65, due electrostatic induction from the plus-charged support member 65, a minus charge is induced at the leading part (a part which becomes the main liquid droplets Md) close to the support member 65, and a plus charge is induced at the trailing end close to the opposite nozzles 64 thereto. As shown in FIG. 7B, when the ink ejected from the nozzles is divided into, for example, the main liquid droplets Md, first satellite liquid droplets Sd1, and second satellite liquid droplets Sd2, the main liquid droplets Md are charged to minus, the second satellite liquid droplets Sd2 are charged to plus, and the first satellite liquid droplets Sd1 are not charged. In this case, even when the main liquid droplets Md and the first satellite liquid droplets Sd1 land on the printing medium P, the second satellite liquid droplets Sd2 become mist in the vicinity of the nozzle formation face of the printing head against the plus-charged support member 65 and are drifted. A part of the mist (aerosol) is attached to the nozzle formation face. When the mist is attached to the nozzle formation face, it is necessary to periodically dispel the nozzle formation face by a wiping member. The mist which is not attached to the nozzle formation face may be attached to printer constituent components with a polarity different from that of the mist to contaminate the component.

From the phenomenon described above, when an electrode is provided in the vicinity of the nozzles and the ejection of the ink from the nozzles starts, the polarity of the electrode may can be switched from plus to minus. Accordingly, a configuration of performing a control of changing the polarity of the electrode to plus again at a timing when the ink ejected from the nozzles divides into the main liquid droplets and the satellite liquid droplets to make the plus-charged satellite liquid droplets far away from the nozzle formation face (close to the printing medium) is proposed (for example, see JP-A-2010-214652). A configuration of ejecting the ink from the nozzle with the support member (base material) charged to, for example, minus, switching the polarity of the support member to plus at the when the ink divides into the main liquid droplets and the satellite liquid droplets, landing the main liquid droplets on the printing medium by inertial force, and attracting the satellite liquid droplets and the mist to the support member charged to the reverse polarity to that of the satellite liquid droplets and the mist land on the printing medium is proposed (for example, see JPA-2010-214880).

However, recently, in such kinds of printers, the driving frequency ejecting the ink tends to increase, and a case occurs where the next ink is ejected from the nozzles before the satellite liquid droplets land on the printing medium. For this reason, in the configuration of changing the polarity of the electrode at the timing of ejecting the ink and at the timing when the ink divides as described above, it is difficult to reliably land the satellite liquid droplets on the printing medium, an influence on flight of the main liquid droplets occurs, and the landing may be unstable.

The electric field is not formed between the nozzle formation face and the support member to prevent the charging of the ink may be conceivable. However, even when the ink is ejected from the nozzle in the configuration, it is known that the ejected ink is charged. That is, for example, as shown in a schematic diagram of FIG. 8, in a configuration of applying a driving voltage to a driving electrode 69 of a piezoelectric vibrator 68 of the printing head to cause pressure fluctuation of the ink in a pressure chamber 70 and ejecting the ink from the nozzles 71 to the printing medium P using the pressure fluctuation, when a positive voltage is input to the driving electrode 69 of the piezoelectric vibrator 68, the piezoelectric vibrator 68 and the pressure chamber 70 are insulated from each other. Accordingly, minus charges are induced by electrostatic induction in the vicinity of the piezoelectric vibrator 68 in the ink in the pressure chamber 70. In addition, plus charges are induced to the ink in the vicinity of the nozzles 71 opposite thereto. In the general printing head, the nozzle formation face 72 is grounded, and thus the plus charges of the ink are moved to the nozzle formation face 72 side. However, as described above, in the configuration ejecting the ink at the higher driving frequency, the ink is ejected from the nozzles 71 in the state where the plus charges slightly remain. As a result, the ink ejected from the nozzles 71 is charged to plus.

The plus charging of the ink ejected from the nozzles 71 tends to be strengthened (when the ink is ejected in the minus-charged state, the minus charging is weakened) by the Lenard effect during the flight toward the printing medium P. That is, when the ink is charged, the plus charges are collected to the center part of the liquid droplets, and the minus charges are collected to the surface layer part. The liquid droplets gradually lean to the plus charging by evaporation or division of the surface layer part during the flight.

As described above, even in the configuration in which the electric field is not formed between the nozzle formation face and the support member, the ink ejected from the nozzles is charged, and thus there is a defect where mist attaches to the nozzle formation face or the printer constituent components.

The phenomenon described above is not limited to the piezoelectric vibrator, and occurs in the other pressure generating unit operated by applying a driving voltage, such as a heat generating element.

### SUMMARY

An advantage of some aspects of the invention is to provide a liquid ejecting head and a liquid ejecting apparatus, capable of more reliably preventing the inside of the apparatus from being contaminated by mist generated at the time of ejecting a liquid.

According to an aspect of the invention, there is provided a liquid ejecting head including a liquid flow path that is provided with nozzles for ejecting a liquid and a pressure chamber communicating with the nozzles; and a pressure generating unit that is driven by applying a driving signal to cause pressure fluctuation of the liquid in the pressure chamber, wherein the liquid is ejected from the nozzles by driving the pressure generating unit, wherein a conductive shielding member is provided between the pressure chamber and the pressure generating unit, and wherein the shielding member and the pressure generating unit are electrically insulated from each other.

In the configuration, the shielding member may be grounded.

According to the aspect of the invention, electrostatic induction on the liquid in the pressure chamber at the time of driving the pressure generating unit is prevented by the shielding member. Accordingly, the liquid droplets ejected from the nozzles are prevented from being charged. As described above, the liquid droplets ejected from the nozzles are not charged as much as possible. Accordingly, even when the liquid droplets are divided while the liquid droplets fly toward the landing target such as a printing medium to generate satellite liquid droplets or mist smaller than that, the charging of the mist or the like is suppressed. Therefore, it is reduced that such mist or the like is attached to constituent components (for example, a driving motor, a driving belt, a linear scale, and the like) in the apparatus. As a result, the breakdown caused by the attachment of the mist is prevented, and durability and reliability of the liquid ejecting apparatus are improved.

In the configuration, the liquid ejecting head may further include a voltage applying unit that applies a voltage to the shielding member.

According to the configuration, by applying the voltage to the shielding member, it is possible to arbitrarily control the charging polarity of the liquid ejected from the nozzles. Accordingly, for example, it is possible to collect the mist by the collecting unit charged to the reverse polarity to the charging polarity of the mist. In addition, for example, the constituent components to which the attachment of the mist has to be avoided are configured by easily charged materials, the mist is charged to the same polarity as the charging polarity of the constituent component, and thus the attachment of the mist is reduced to the constituent components.

According to another aspect of the invention, there is provided a liquid ejecting apparatus including a liquid ejecting head, wherein the liquid ejecting head includes a liquid flow path that is provided with nozzles for ejecting a liquid and a pressure chamber communicating with the nozzles, and a pressure generating unit that is driven by applying a driving signal to cause pressure fluctuation of the liquid in the pressure chamber, wherein the liquid is ejected from the nozzles by driving the pressure generating unit, wherein a conductive shielding member is provided between the pressure chamber and the pressure generating unit, and wherein the shielding member and the pressure generating unit are electrically insulated from each other.

In the configuration, the liquid ejecting apparatus may further include a collection unit that collects mist generated by dividing the liquid ejected from the liquid ejecting head to a landing target; a first voltage applying unit that applies a voltage to the shielding member; and a second voltage applying unit that applies a voltage to the collection unit, wherein the first voltage applying unit and the second voltage applying unit generate voltages with polarities reverse to each other.

### BRIEF DESCRIPTION OF THE DRAWINGS

The invention will be described with reference to the accompanying drawings, wherein like numbers reference like elements.

FIG. 1 is a perspective view illustrating a configuration of a printer.

FIG. 2 is a cross-sectional view of a main part of a printing head.

FIG. 3 is a cross-sectional view illustrating a configuration of a piezoelectric vibrator.

FIG. 4 is a block diagram illustrating an electric configuration of the printing head.

FIG. 5 is a waveform diagram illustrating a configuration of an ejection driving pulse and a micro-vibration driving pulse.

FIG. 6A and FIG. 6B are diagrams illustrating collection of mist.

FIG. 7A and FIG. 7B are diagrams illustrating that an ink ejected from a nozzle is charged in a configuration in which electric field is formed between nozzles and a support member.

FIG. 8 is a schematic diagram illustrating that an ink ejected from a nozzle is charged in a configuration in which electric field is not formed between nozzles and a support member.

### DESCRIPTION OF EXEMPLARY EMBODIMENTS

Hereinafter, embodiments of the invention will be described with reference to the accompanying drawings. The embodiments described hereinafter are variously limited as preferred specific examples of the invention, but the scope of the invention is not limited to such aspects as long as there is no description particularly limiting the invention in the following claim. In the following description, as the liquid ejecting apparatus of the invention, an ink jet printing apparatus (hereinafter, referred to as a printer) is described as an example.

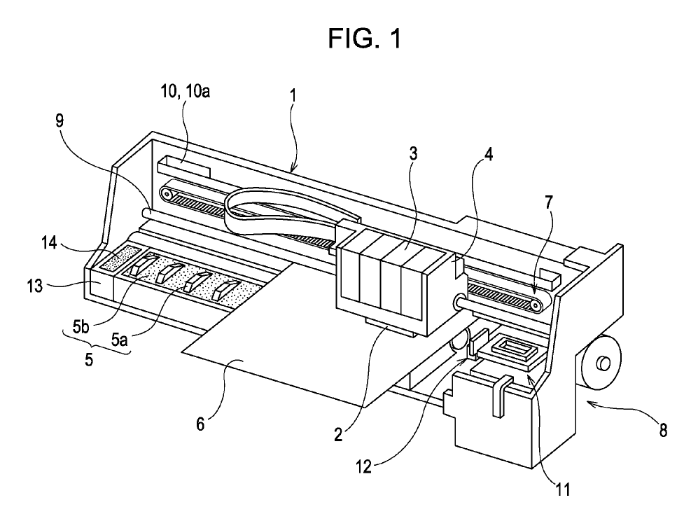

FIG. 1 is a perspective view illustrating a configuration of a printer 1. The printer 1 is provided with a printing head 2 that is a kind of liquid ejecting head, and includes a carriage 4 on which an ink cartridge 3 as a kind of liquid supply source is detachably mounted, a platen 5 that is provided under the printing head 2 at the time of a printing operation, a carriage moving mechanism 7 that reciprocally moves the carriage 4 in a sheet width direction of a printing sheet 6 (a kind of printing medium and landing target), that is, a main scanning direction, and a transport mechanism 8 that transports the printing sheet 6 in a sub-scanning direction perpendicular to the main scanning direction.

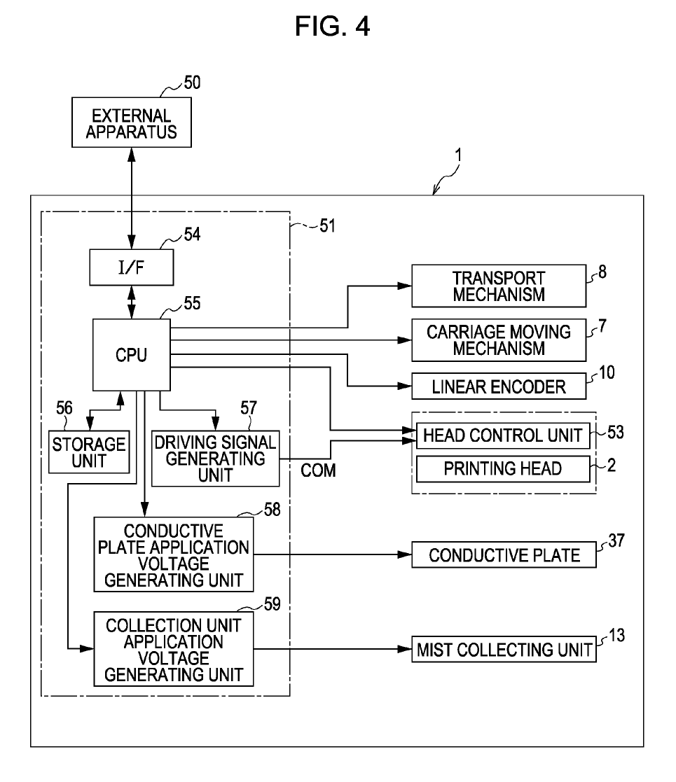

The carriage 4 is axially supported to and mounted on a guide rod 9 provided in the main scanning direction, and is moved in the main scanning direction along the guide rod 9 by the operation of the carriage moving mechanism 7. The position of the carriage 4 in the main scanning direction is detected by a linear encoder 10, and a detection signal thereof, that is, an encoder pulse (a kind of position information) is transmitted to a printer controller 51 (see FIG. 4). The linear encoder 10 is a kind of position information output unit, and outputs an encoder pulse EP corresponding to the scanning position of the printing head 2 as position information in the main scanning direction. The linear encoder 10 includes a linear scale 10a that is provided along the main scanning direction in an inner wall of a rear face of a frame 2, and a detection unit (not shown) that is mounted on a rear face of the carriage 3. As a detection type of the linear encoder 10, there are an optical type and a magnetic type, and in the embodiment, the optical type is employed. The linear scale 10a is formed of a stripe-shaped resin film. In the embodiment, a plurality of longitudinal slits (longitudinal slits in a band width direction) (not shown) are formed along a longitudinal direction of a base material of the linear scale 10a. The detection unit outputs an encoder pulse according to a difference between a light reception state in the slits of the linear scale 10a and a light reception state in a part other than the slits.

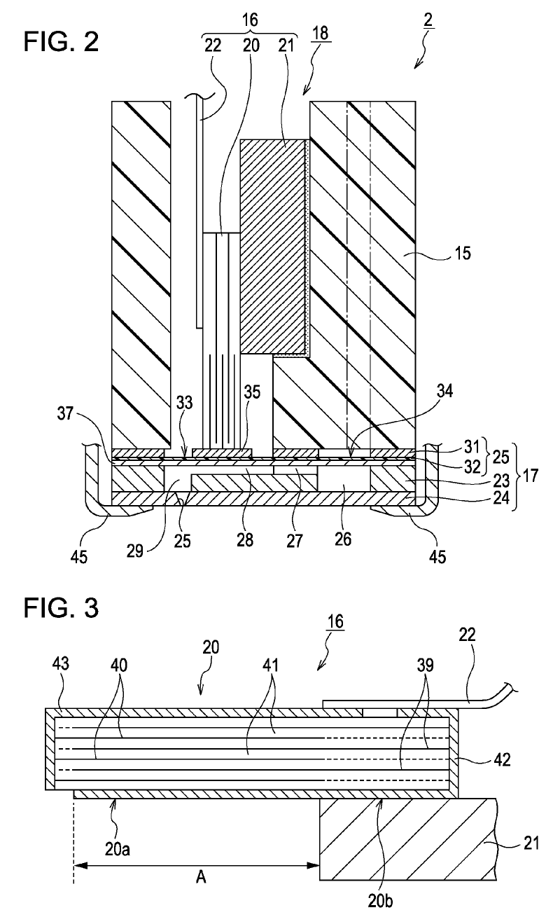

At an end portion area on the outside from the printing area in the movement range of the carriage 4, a home position that is a base point of the scanning of the carriage is set. At the home position in the embodiment, a capping member 11 that seals the nozzle formation face (nozzle plate 24: see FIG. 2) of the printing head 2, and a wiper member 12 that dispels the nozzle formation face are disposed. The printer 1 is configured to perform so-called two-way printing of printing characters and images on the printing sheet 6 in two directions of the forward movement time of moving the carriage 4 from the home position to the opposite end portion and the backward movement time of returning the carriage 4 from the opposite end portion to the home position.

The platen 5 is a plate-shaped member which is longitudinal in the main scanning direction, and a plurality of support protrusions 5a are provided on a surface thereof at a predetermined interval along the longitudinal direction. The support protrusions 5a protrude upward (the printing head 2 side at the time of printing operation) from the platen face. The upper face of each support protrusions 5a is a contact face supporting the printing sheet 6, and partially supports the rear face (the opposite face to the printing face on which the ink lands) of the printing sheet 6. At a part deviating from the support protrusions 5a on the surface of the platen 5, an ink absorbing material 5b is provided. The ink absorbing material 5b is formed of, for example, a porous member having liquid absorptiveness produced by felt or sponge.

At the end portion of the plate 5 in the main scanning direction, specifically, in an area deviating from an area (ink ejection area) where the ink is ejected to the printing sheet 6 on the platen 5, more specifically, at a position on the outside from the width direction end portion (maximum printing sheet width) of the printing sheet 6 when the printing sheet 6 with the maximum size supported by the printer 1 is disposed on the platen 5 in an area deviating from the ink ejection area to the outside in the main scanning direction, a mist collecting unit 13 (corresponds to the collection unit in the invention) that collects mist (aerosol) generated when ejecting the ink from the printing head 2 is provided. It is preferable that the mist collecting units 13 are provided on both sides of the platen 5 in the main scanning direction, but the mist collection unit 13 may be provided at least on one side. The mist collecting unit 13 in the embodiment is formed in a box shape from a member having an insulating property. On the upper face of the mist collecting unit 13, the mist absorbing member 14 is provided. The mist absorbing member 14 is formed including a conductive material such as carbon in a porous member having a liquid absorbing property produced by, for example, urethane sponge. A voltage from a collection unit application voltage generating unit 59 to be described later is applied to the mist absorbing member 14. Details of this point will be described later. Since the mist collecting unit 13 (more specifically, the mist absorbing member 14) is charged by applying the voltage, it is possible to prevent the influence of the charging from the mist collecting unit 13 on the ejected ink by disposing the mist collecting unit 13 at the position described above when the ink is ejected from the printing head 2 to the printing sheet 6. The mist collecting unit 13 also serves as a reception unit (flushing point) receiving the ejected ink at a recovering process (flushing process) of suppressing thickening of the ink in the printing head 2 by ejecting the ink from the nozzles 30 separately from the ejection (that is, a printing process) to the printing sheet 6. For this reason, it is possible to contribute to space saving in the printer.

FIG. 2 is a cross-sectional view of a main part illustrating a configuration of the printing head 2. The printing head 2 includes a case 15, a vibrator unit 16 housed in the case 15, a flow path unit 17 coming in contact with a bottom face (leading end face) of the case 15, a cover member 45, and the like. The case 15 is produced by, for example, epoxy resin, and a housing empty portion 18 for housing the vibrator unit 16 is formed therein. The vibrator unit 16 includes a piezoelectric vibrator 20 serving as a kind of pressure generating unit, a fixing plate 21 coming in contact with the piezoelectric vibrator 20, and a flexible cable 22 for supplying a driving signal to the piezoelectric vibrator 20.

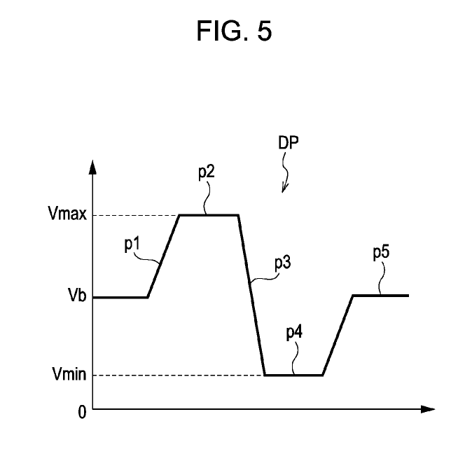

FIG. 3 is a cross-sectional view in an element longitudinal direction illustrating a configuration of the vibrator unit 16. As shown in FIG. 3, the piezoelectric vibrator 20 is a lamination-type piezoelectric vibrator formed by alternately laminating a common internal electrode 39 and an individual internal electrode 40 with a piezoelectric body 41 interposed therebetween. The common internal electrode 39 is an electrode common in all the piezoelectric vibrators 20, and is set to a ground potential. The individual internal electrode 40 is an electrode, the potential of which fluctuates according to the ejection driving pulse DP (see FIG. 5) of the applied driving signal. In the embodiment, a part of about a half or about ⅔ in the longitudinal direction (a direction perpendicular to the lamination direction) of the vibrator from the vibrator leading end in the piezoelectric vibrator 20 is a free end portion 20a. The other part in the piezoelectric vibrator 20, that is, a part from a base end of the free end portion 20a to the vibrator base end is a base end portion 20b.

At the free end portion 20a, an active area (overlap part) A where the common internal electrode 39 and the individual internal electrode 40 are overlapped with each other is formed. When a potential difference is applied to the internal electrodes 39 and 40, the piezoelectric body 41 of the active area A operates and is deformed, and the position of the free end portion 20a is changed to extend and contract in the vibrator longitudinal direction. The base end of the common internal electrode 39 is electrically connected to a common external electrode 42 at the base end face portion of the piezoelectric vibrator 20. The leading end of the individual internal electrode 40 is electrically connected to an individual external electrode 43 at the leading end face portion of the piezoelectric vibrator 20. The leading end of the common internal electrode 39 is positioned slightly before the leading end face portion of the piezoelectric vibrator 20, and the base end of the individual internal electrode 40 is positioned at the boundary between the free end portion 20a and the base end portion 20b.

The individual external electrode 43 (corresponding to the driving electrode in the invention) is an electrode formed in a series of the leading end face portion of the piezoelectric vibrator 20 and the wiring connection face (the upper face in FIG. 3) that is one side face in the lamination direction in the piezoelectric vibrator 20, and electrically connects a wiring pattern of a flexible cable 22 as a wiring member to the individual internal electrode 40. A part on the individual external electrode 43 on the wiring connection face side is continuously formed toward the leading end side on the base end portion 20b. The common external electrode 42 is an electrode formed in a series of the base end face portion of the piezoelectric vibrator 20, the wiring connection face, and a fixing plate installation face (lower face in FIG. 3) that is the other side face in the lamination direction in the piezoelectric vibrator 20, and connects the wiring pattern of the flexible cable 22 to the common internal electrodes 39. A part on the wiring connection face side in the common external electrode 42 is continuously formed from a position slightly in front of the end portion of the individual external electrode 43 to the base end face portion side, and a part of the fixing portion installation face side is continuously formed from a position slightly in front of the leading end face portion of the vibrator to the base end side.

The base end portion 20b is a non-operation portion which does not extend and contract at the time of operation of the piezoelectric body 41 of the active area A. A flexible cable 18 is disposed on the wiring connection face side of the base end portion 20b, and the individual external electrode 43, the common external electrode 42, and the flexible cable 22 are electrically connected on the base end portion 20b. The driving signal is applied to the individual external electrodes 43 through the flexible cable 22.

The flow path unit 17 is configured in which the nozzle plate 24 comes in contact with one face of the flow path formed substrate 23, and the vibration plate 25 comes in contact with the other face of the flow path formed substrate 23 with the conductive plate 37 (corresponding to the shielding member in the invention) interposed therebetween. The flow path unit 17 is provided with a reservoir 26 (common liquid chamber), an ink supply port 27, a pressure chamber 28, a nozzle communication portion 29, and a nozzle 30. A series of ink flow path (corresponding to the liquid flow path in the invention) from the ink supply port 27 through the pressure chamber 28 and the nozzle communication portion 29, to the nozzles 30 is formed corresponding to the nozzles 30.

The nozzle plate 24 is a thin plate formed of metal such as stainless steel in which the plurality of nozzles 30 are formed in a row shape at pitches (for example, 180 dpi) corresponding to dot formation density. The nozzle plate 24 is provided with the nozzles 30 in line, a plurality of nozzle rows (nozzle group) are provided, and one nozzle row is configured by, for example, 180 nozzles 30.

The vibration plate 25 has a double structure in which an elastic film 32 is laminated on the surface of the support plate 31. In the embodiment, the stainless plate that is a kind of metal plate is the support plate 31, and the vibration plate 25 is produced using a complex plate material formed by laminating a resin film as the elastic film 32 on the surface of the support plate 31. The vibration plate 25 is provided with a diaphragm unit 33 that changes a volume of the pressure chamber 28. The vibration plate 25 is provided with compliance unit 34 that seals a part of the reservoir 26.

The diaphragm unit 33 is produced by partially removing the support plate 31 by an etching process or the like. That is, the diaphragm unit 33 is formed of an insular portion 35 coming in contact with the leading end face of the free end portion 20a of the piezoelectric vibrator 20, and a thin-walled elastic portion surrounding the insular portion 35. The compliance unit 34 is produced by removing the support plate 31 in an area opposed to the opening face of the reservoir 26 by the etching process or the like, similarly to the diaphragm unit 33, and serves as a dumper absorbing the pressure fluctuation of the liquid stored in the reservoir 26.

Since the insular portion 35 comes in contact with the leading end face of the piezoelectric vibrator 20, it is possible to fluctuate the volume of the pressure chamber 28 by extending and contracting the free end portion 20a of the piezoelectric vibrator 20. The pressure fluctuation occurs in the ink in the pressure chamber 28 according to the volume fluctuation. The printing head 2 ejects the ink from the nozzles 30 using the pressure fluctuation.

The conductive plate 37 is formed of a thin metal plate (metal film) and has flexibility. At the time of driving the piezoelectric vibrator 20, the conductive plate 37 is deformed according to the displacement of the diaphragm unit 33. The conductive film 37 comes in contact with the elastic film 32 side of the vibration plate 25, and is electrically insulated from the support plate 31 and the piezoelectric vibrator 20 by the elastic film 32. The conductive film 37 seals the opening face of the pressure chamber 28, and comes in contact with the ink in the pressure chamber 28. The conductive plate 37 in the embodiment is electrically connected to a conductive plate application voltage generating unit 58 to be described later, and the voltage from the conductive plate application voltage generating unit 58 is applied thereto. Details of this point will be described later. The conductive plate 37 is electrically connected to the conductive plate application voltage generating unit 58 to be grounded, and also serves as an electrostatic shielding member that prevents electrostatic induction on the ink in the pressure chamber 28 at the time of driving the piezoelectric vibrator 20.

The cover member 45 is a member that protects the side face of the flow path unit 17 and the side face of the head case 41, and is produced from a conductive plate member such as stainless steel. A part of the cover member 45 in the embodiment comes in contact with a peripheral portion of the nozzle formation face in a state where the nozzles 30 of the nozzle plate 24 are exposed, and is electrically connected to the nozzle plate 24. The cover member 45 is grounded, and comes in contact with the nozzle plate 24 to be electrically connected. Accordingly, for example, damage to a driving IC and the like or the charging of the nozzle plate 24 caused by transmission of electrostatics generated from the printing sheet 6 or the like through the nozzle plate 24 is prevented.

Next, an electrical configuration of the printer 1 will be described.

FIG. 4 is a block diagram illustrating the electrical configuration of the printer 1. An external apparatus 50 is an electronic apparatus which handles, for example, an image of a computer, a digital camera, or the like. The external apparatus 50 is connected to communicate with the printer 1, causes the printer 1 to print an image or a text on a printing medium such as the printing sheet 6, and thus transmits printing data corresponding to the image or the like to the printer 1.

The printer 1 in the embodiment includes a transport mechanism 8, a carriage moving mechanism 7, a linear encoder 10, a printing head 2, a conductive plate 37, a mist collecting unit 13, and a printer controller 51.

The printer controller 51 is a control unit for controlling units of the printer. The printer controller 51 includes an interface (I/F) unit 54, a CPU 55, a storage unit 56, a driving signal generating unit 57, and a collection unit application voltage generating unit 59. The interface unit 54 performs transmission and reception of printer state data, for example, printing data or a printing command is transmitted from the external apparatus 50 to the printer 1 or the external apparatus 50 receives state information of the printer 1. The CPU 55 is an operation processing device for performing a control of the whole of the printer. The storage unit 56 is an element that stores programs executed by the CPU 55 or data used in various controls, and includes a ROM, a RAM, and an NVRAM (nonvolatile storage element). The CPU 55 controls the units according to the programs stored in the storage unit 56.

The CPU 55 serves as a timing pulse generating unit that generates a timing pulse PTS from the encoder pulse EP output from the linear encoder 10. The CPU 55 controls transmission of the printing data or generation of a driving signal COM based on the driving signal generating unit 57, synchronizing with the timing pulse PTS. The CPU 55 generates a timing signal such as a latch signal LAT on the basis of the timing pulse PTS, and outputs the timing signal to the head control unit 53 of the printing head 2. The head control unit 53 performs a control of applying an ejection driving pulse DP (see FIG. 5) of the driving signal COM on the piezoelectric vibrator 20 of the printing head 2 on the basis of the head control signal (printing data and timing signal) from the printer controller 51.

The conductive plate application voltage generating unit 58 (first voltage applying unit in the invention) is a power supply that generates a voltage applied to the conductive plate 37. The conductive plate application voltage generating unit 58 applies a voltage with the reverse polarity to that of a collection unit application voltage generating unit 59 to be described later, that is, a minus voltage in the embodiment to the conductive plate 37. The conductive plate application voltage generating unit 58 is controlled to be turned on and off by the CPU 55. Specifically, the conductive plate application voltage generating unit 58 is continuously turned on while the ejection operation of the ink is performed by the printing head 2. Accordingly, the voltage of the minus polarity is applied to the conductive plate 37, and negative charges are moved from the conductive plate 37 to the ink in the pressure chamber 28. Accordingly, as will be described later, the ink ejected from the nozzles 30 of the printing head 2 is charged to minus. In the state where the ink is not ejected (pause state or power-off state of printer), the conductive plate application voltage generating unit 58 is switched to be turned off. Accordingly, the voltage is not applied to the conductive plate 37.

The collection unit application voltage generating unit 59 (corresponding to the second voltage applying unit in the invention) is a power supply that generates a voltage to the mist absorbing member 14 of the mist collecting unit 13. The voltage of the polarity reverse to the polarity of the voltage generated by the conductive plate application voltage generating unit 58, that is, a voltage of a plus polarity in the embodiment is applied to the mist absorbing member 14, and thus the mist absorbing member 14 is charged to plus. The collection unit application voltage generating unit 59 is controlled to be turned on or off by the CPU 55. Specifically, when the printing head 2 moves to the upside of the mist collecting unit 13 and the nozzle formation face and the mist absorbing member 14 are opposed (both are overlapped in a plane parallel to the nozzle formation face), the collection unit application voltage generating unit 59 can be switched to be turned on. Accordingly, the voltage is applied to the mist absorbing member 14, and electric field is formed between the mist absorbing member 14 and the nozzle formation face of the printing head. Accordingly, when the mist is generated by the ejection of the ink, electrostatic force from the mist absorbing member 14 acts on the minus-charged mist, and the mist can be collected by the mist absorbing member 14. When the printing head 2 moves to the ink ejection area side of the plate 5 and the nozzle formation face is not opposed to the mist collecting unit 13 (not overlapped in the plan view), the collection unit application voltage generating unit 59 can be switched to be turned off. Accordingly, the voltage is not applied to the mist absorbing member 14.

The driving signal generating unit 57 generates an analog voltage signal on the basis of waveform data based on the waveform of the driving signal. The driving signal generating unit 57 amplifies the voltage signal and generates the driving signal COM. The driving signal COM is applied to the piezoelectric vibrator 20 that is the pressure generating unit of the printing head 2 at the time of the printing process (printing process or ejection process) on the printing medium, and is, for example, a series of signal including at least one ejection driving pulse DP shown in FIG. 5, within a unit period that is a repetition cycle. The ejection driving pulse DP causes the piezoelectric vibrator 20 to perform a predetermined operation to eject the ink of liquid droplets from the nozzles 30 of the printing head 2.

FIG. 5 is a waveform diagram illustrating an example of a configuration of the ejection driving pulse DP included in the driving signal COM. In FIG. 5, the vertical axis represents potential, and the horizontal axis represents time. The ejection driving pulse DP includes an expansion element p1 of changing the potential from a reference potential (intermediate potential) Vb to the maximum potential (maximum voltage) Vmax to the plus side to expand the pressure chamber 28, an expansion holding element p2 of holding the maximum potential Vmax during a predetermined time, a contract element p3 of changing the potential from the maximum potential Vmax to the minimum potential (minimum voltage) Vmin to the minus side to rapidly contract the pressure chamber 28, a contract holding (vibration suppression hold) element p4 of keeping the minimum potential Vmin at a predetermined time, and a returning element p5 of returning the potential from the minimum potential Vmin to the reference potential Vb. The ejection driving pulse DP in the embodiment has an overall plus voltage waveform since the minimum potential (minimum voltage) Vmin is 0 volt or higher, but may partially represent a minus value, for example, from the relationship with a bias voltage applied to the common external electrode 42. In this case, the voltage of the ejection driving pulse DP is the average plus.

When the ejection driving pulse DP is applied to the piezoelectric vibrator 20, the following operation is performed. First, the piezoelectric vibrator 20 is contracted by the expansion element p1, and thus the pressure chamber 28 is expanded from the reference volume corresponding to the reference potential Vb to the maximum volume corresponding to the maximum potential Vmax. Accordingly, the meniscus exposed to the nozzle 30 is attracted to the pressure chamber side. The expansion state of the pressure chamber 28 is kept constant during the application period of the expansion holding element p2. When the contract element p3 is applied to the piezoelectric vibrator 20 after the expansion holding element p2, the piezoelectric vibrator 20 is extended. Accordingly, the pressure chamber 28 is rapidly contracted from the maximum volume to the minimum volume corresponding to the minimum potential Vmin. The ink in the pressure chamber 28 is pressurized by the rapid contraction of the pressure chamber 28, and thus the ink of several p1 to several tens of p1 is ejected from the nozzles 30. The contraction state of the pressure chamber 28 is kept for a short time in the application period of the contract holding element p4, then the vibration returning element p5 is applied to the piezoelectric vibrator 20, and the pressure chamber 28 is returned from the volume corresponding to the minimum potential Vmin to the reference volume corresponding to the reference potential Vb.

The printer 1 according to the invention is characterized in that the voltage is applied to the conductive plate 37 to positively charge the ink ejected from the nozzles 30, and the mist generated by dividing the ink during flight is collected by the mist collecting member 14 of the mist collecting unit 13.

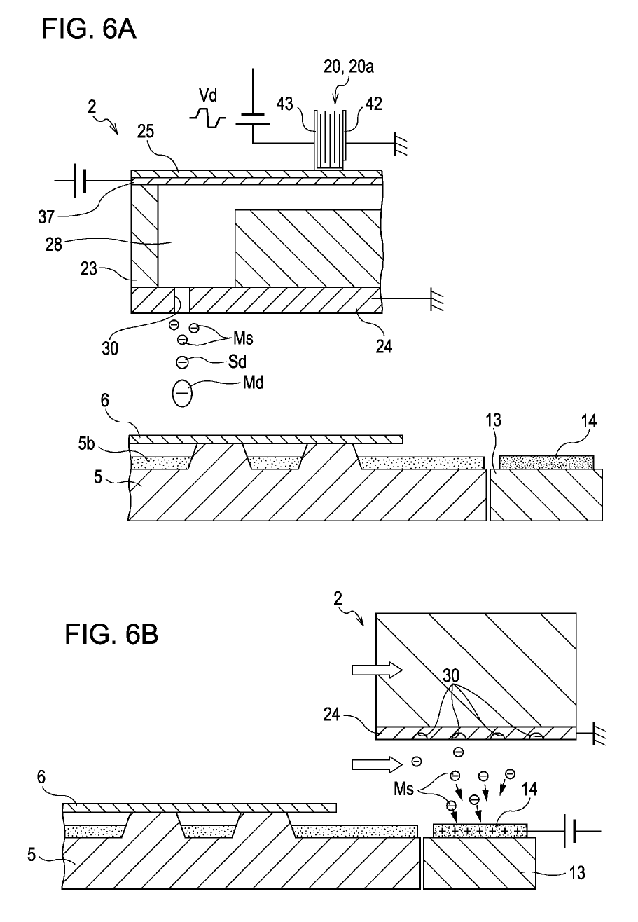

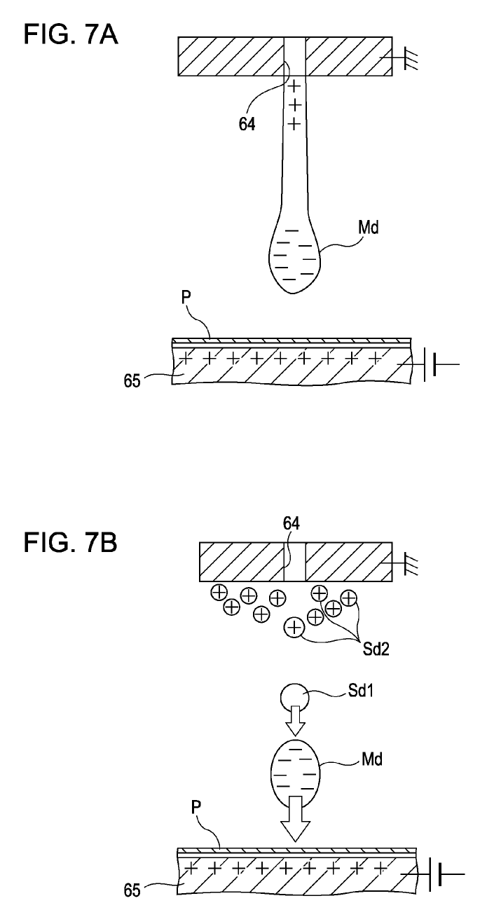

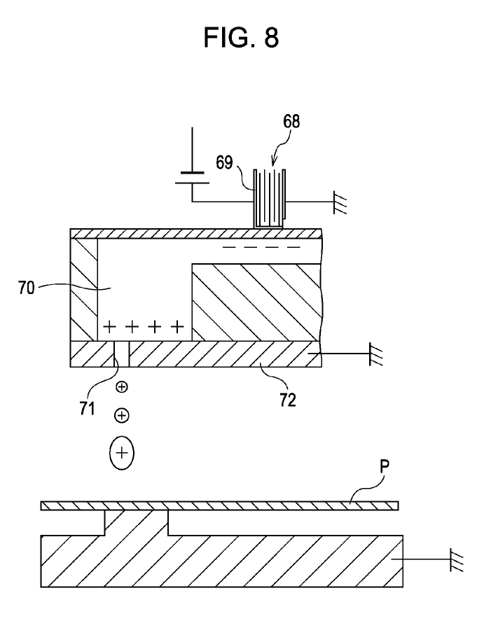

FIG. 6A and FIG. 6B are schematic diagrams illustrating the collection of the mist. In FIG. 6A, the printing head 2 is shown as a partial cross-sectional view.

As described above, the conductive plate 37 is provided between the pressure chamber 28 and the piezoelectric vibrator 20, the conductive plate 37 and the piezoelectric vibrator 20 are electrically insulated by the elastic film 32 of the vibrator plate 25, and thus the electrostatic induction on the ink in the pressure chamber 28 is prevented by the conductive plate 37 serving as the shielding member when the driving pulse (that is, plus voltage) is applied to the driving electrode (individual external electrode 43) of the piezoelectric vibrator 20. Since the conductive plate 37 comes in contact with the ink in the pressure chamber, the minus voltage is applied to the conductive plate 37 by the conductive plate application voltage generating unit 58, and thus the negative charges are moved from the conductive plate 37 to the ink in the pressure chamber 28. In this state, the ink droplets ejected from the nozzles 30 are charged to minus. The ink droplets are divided into, for example, main liquid droplets Md, satellite liquid droplets Sd, and mist Ms, until the ink droplets land on the printing sheet 6. The main liquid droplets Md of the leading part reach the printing sheet 6 by the inertial force at the time of ejection. However, liquid droplets with relatively little mass among the satellite liquid droplets Sd or the mist Ms with even less mass may drift in the vicinity of the nozzle formation face without landing on the printing sheet 6.

The mist Ms or the like which does not land on the printing sheet 6 is moved according to the printing head 2 by the negative pressure generated by the movement of the printing head 2. As shown in FIG. 6B, when the printing head 2 moves to the upside of the mist collecting unit 13 over the ink ejection area of the plate 5 and the maximum printing sheet width and the nozzle formation face is opposed to the mist absorbing member 14, the plus voltage is applied from the collection unit application voltage generating unit 59 to the mist absorbing member 14 and the mist absorbing member 14 is charged to plus. Accordingly, the mist Ms or the like having the negative charges floating in the vicinity of the printing head 2 is adsorbed and collected to the mist absorbing member 14 by the electrostatic force. As described above, when the printing head 2 moves to the ink ejection area side of the plate 5 and the nozzle formation face is not opposed to the mist absorbing member 14, the voltage is not applied to the mist absorbing member 14. For this reason, while the printing head 2 ejects the ink to the printing sheet 6, the influence of the charging of the mist absorbing member 14 is not affected on the ejected ink. Since the voltage is not applied to the mist absorbing member 14 until the nozzle formation face is opposed to the mist absorbing member 14, the mist or the like is prevented from being attached to the end portion of the printing sheet 6 in the width direction while the printing head 2 moves toward the mist collecting unit 13.

By employing the configuration described above, the electrostatic induction on the ink in the pressure chamber 28 at the time of driving the piezoelectric vibrator 20 is prevented by the conductive plate 37, and the ink ejected from the nozzles 30 is prevented from being charged to an unintended polarity. By applying the voltage to the conductive plate 37, it is possible to positively charge the ink ejected from the nozzles 30, and thus it is possible to more reliably collect the mist by the mist collecting unit 13 charged to the opposite polarity to the charging polarity. As a result, since the mist is not easily attached to the constituent components (for example, easily charged components such as a driving motor, a driving belt, and a linear scale) in the printer, the breakdown caused by the attachment of the mist is suppressed, and durability and reliability of the printer 1 are improved.

However, the invention is not limited to the embodiment described above, and may be variously modified on the basis of the description of Claims.

For example, in the embodiment, the configuration is exemplified in which the minus voltage is applied to the conductive plate 37, the ink ejected from the nozzles 30 is charged to minus, the mist collecting unit 13 is charged to plus, and the mist is thereby collected, but the invention is not limited thereto. However, a configuration may be employed in which the plus voltage is applied to the conductive plate 37, the ink ejected from the nozzles 30 is charged to plus, the mist collecting unit 13 is charged to minus, and the mist is thereby collected.

Concerning the mist collecting unit 13, in the embodiment, the configuration of charging the mist absorbing member 14 by applying the voltage to the conductive mist absorbing member 14 has been exemplified, but is not limited thereto, and a configuration of directly applying the voltage to the conductive mist collecting unit 13 may be applied without providing the mist absorbing member 14. As the mist absorbing member 14 or the mist collecting unit 13, it is possible to use a material having a property of being easily charged to the opposite polarity to the charging polarity of the mist. For example, as a material easily charged to the negative polarity in the charging row, a sponge or the like formed of silicone, polypropylene, and polyvinyl chloride may be employed. As a material easily charged to the positive polarity in the charging row, a sponge formed of nylon and a wool absorbing material may be employed. With such a configuration, since the mist absorbing member 14 or the mist collecting unit 13 is charged to the opposite polarity to the charging polarity of the mist, the power supply such as the collection unit application voltage generating unit 59 is not necessary, and it is possible to obtain the collection effect of the mist with a simpler configuration.

In the embodiment, the configuration of applying the voltage to the conductive plate 37 to charge the ink ejected from the nozzles 30 and collecting the mist divided from the ink by the mist collecting unit 13 to which the voltage of the polarity reverse to the charging polarity of the mist is applied has been exemplified, but the invention is not limited thereto, and it is possible to suppress defects caused by the mist by various methods using the fact that it is possible to arbitrarily control the charging polarity of the ink ejected from the nozzles 30. For example, a configuration may be employed in which the linear scale 10a by which it is difficult to detect the position of the printing head 2 when the mist is attached is formed of resin easily charged to minus, the voltage (in this example, plus voltage) of the same polarity as the charging polarity of the linear scale 10a is applied to the conductive plate 37, and the ink ejected from the nozzles 30 is charged to minus. In the configuration, since the mist is charged to the same polarity as the charging polarity of the linear scale 10a, a repulsive force is generated between the mist and the linear scale 10a, and thus it is reduced that the mist is attached to the linear scale 10a.

For example, the conductive plate 37 may be grounded without providing the conductive plate application voltage generating unit 58. In this case, the electrostatic induction on the ink in the pressure chamber 28 at the time of driving the piezoelectric vibrator 20 is prevented by the conductive plate 37, and thus the charging of the main droplets of the ink ejected from the nozzles 30 and the mist generated by dividing the main droplets of the ink is reduced. Accordingly, it is reduced that the mist is attached to the constituent components in the printer. In this case, the disposition of the conductive plate 37 is not limited to the position exemplified in the embodiment described above between the piezoelectric vibrator 20 and the pressure chamber 28, and for example, may be the position between the vibrator plate 25 and the piezoelectric vibrator 20. When this configuration is employed, it is necessary to electrically insulate the vibration plate 25 and the piezoelectric vibrator 20 from each other.

In the embodiments, as the pressure generating unit, a so-called longitudinal vibration type piezoelectric vibrator 20 has been exemplified, but the invention is not limited thereto, and for example, a so-called deflection type piezoelectric vibrator may be employed. In this case, the waveform of the driving signal (ejection driving pulse DP) exemplified in FIG. 5 becomes a waveform in which the direction of change of potential, that is, the upside and the downside are reversed. In addition, as the pressure generating unit, the invention may be applied to a configuration of employing the pressure generating unit driven by applying a voltage, such as a heat generating element that bumps the ink by the heat generation to cause pressure fluctuation and an electrostatic actuator that changes a position of a partition wall of the pressure chamber by electrostatic force to cause pressure fluctuation.

The invention is not limited to the printer when the apparatus of the invention is a liquid ejecting apparatus capable of controlling ejection of a liquid using the pressure generating unit, and may be applied to various ink jet printing apparatuses such as a plotter, a facsimile apparatus, and a copy machine, or a liquid ejecting device other than the printing device, for example, a display producing device, an electrode producing device, and a chip producing device. In the display producing device, solutions of color materials of R (Red), G (Green), and B (Blue) are ejected from a color material ejecting head. In the electrode producing device, a liquid electrode material is ejected from an electrode material ejecting head. In the chip producing device, a solution of a bio-organic material is ejected from a bio-organic ejecting head.

What is claimed is:

1. A liquid ejecting head comprising:
a liquid flow path that is provided with nozzles for ejecting a liquid and a pressure chamber communicating with the nozzles; and
a pressure generating unit that is driven by applying a driving signal to cause pressure fluctuation of the liquid in the pressure chamber,
wherein the liquid is ejected from the nozzles by driving the pressure generating unit,
wherein a conductive shielding member is provided between the pressure chamber and the pressure generating unit, and
wherein the shielding member and the pressure generating unit are electrically insulated from each other.

2. The liquid ejecting head according to claim 1, wherein the shielding member is grounded.

3. The liquid ejecting head according to claim 1, further comprising a voltage applying unit that applies a voltage to the shielding member.

4. A liquid ejecting apparatus comprising:
a liquid ejecting head, wherein the liquid ejecting head includes a liquid flow path that is provided with nozzles for ejecting a liquid and a pressure chamber communicating with the nozzles, and a pressure generating unit that is driven by applying a driving signal to cause pressure fluctuation of the liquid in the pressure chamber,
wherein the liquid is ejected from the nozzles by driving the pressure generating unit,
wherein a conductive shielding member is provided between the pressure chamber and the pressure generating unit, and
wherein the shielding member and the pressure generating unit are electrically insulated from each other.

5. The liquid ejecting apparatus according to claim 4, further comprising:
a collection unit that collects mist generated by dividing the liquid ejected from the liquid ejecting head to a landing target;
a first voltage applying unit that applies a voltage to the shielding member; and
a second voltage applying unit that applies a voltage to the collection unit,
wherein the first voltage applying unit and the second voltage applying unit generate voltages with polarities reverse to each other.
